(19) United States
(12) Patent Application Publication
(10) Pub. No.: US 2020/0212581 A1
(43) Pub. Date: Jul. 2, 2020

(54) DIELECTRIC RESONATOR ANTENNA-IN-PACKAGE SYSTEM AND MOBILE TERMINAL

(71) Applicant: AAC Technologies Pte. Ltd., Singapore City (SG)

(72) Inventors: Zhimin Zhu, Shenzhen (CN); Xiaoyue Xia, Shenzhen (CN); Zhengdong Yong, Shenzhen (CN); Chao Wang, Shenzhen (CN)

(21) Appl. No.: 16/702,586

(22) Filed: Dec. 4, 2019

(30) Foreign Application Priority Data
Dec. 29, 2018 (CN) 201811645984.3

(51) Int. Cl. H01Q 9/04; H01Q 1/38; H01Q 1/24

(52) U.S. Cl. CPC H01Q 9/0485; H01Q 1/243; H01Q 1/38

(57) ABSTRACT

The present disclosure provides a dielectric resonator antenna-in-package system applied to a mobile terminal. The mobile terminal includes a mainboard. The dielectric resonator antenna-in-package system includes a substrate, a dielectric resonator antenna provided on a side of the substrate facing away from the mainboard, an integrated circuit chip provided on a side of the substrate close to the mainboard, and a circuit provided in the substrate and connecting the dielectric resonator antenna with the integrated circuit chip. The circuit is connected to the mainboard.

### TECHNICAL FIELD

The present disclosure relates to the field of antenna technologies, and in particular, to a dielectric resonator antenna-in-package system and a mobile terminal.

### BACKGROUND

With 5G being the focus of research and development in the global industry, developing 5G technologies and formulating 5G standards have become the industry consensus. The ITU-RWP5D 22nd meeting held in June 2015 by International Telecommunication Union (ITU) identified three main application scenarios for 5G: enhance mobile broadband, large-scale machine communication, and highly reliable low-latency communication. These three application scenarios respectively correspond to different key indicators, and in the enhance mobile broadband scenario, the user peak speed is 20 Gbps and the minimum user experience rate is 100 Mbps. 3GPP is working on standardization of 5G technology. The first 5G Non-Stand Alone (NSA) international standard was officially completed and frozen in December 2017, and the 5G Stand Alone standard was scheduled to be completed in June 2018. Research work on many key technologies and system architectures during the 3GPP conference was quickly focused, including the millimeter wave technology. The high carrier frequency and large bandwidth characteristics unique to the millimeter wave are the main means to achieve 5G ultra-high data transmission rates.

The rich bandwidth resources of the millimeter wave band provide a guarantee for high-speed transmission rates. However, due to the severe spatial loss of electromagnetic waves in this frequency band, wireless communication systems using the millimeter wave band adopts an architecture of a phased array. The phases of respective array elements are caused to distribute according to certain regularity by a phase shifter, so that a high gain beam is formed and the beam is scanned over one spatial range through a change in phase shift.

With an antenna being an indispensable component in a radio frequency (RF) front-end system, it is an inevitable trend in the future development of the RF front-end to system-integrate and package the antenna with a RF front-end circuit while developing the RF circuit towards the direction of integration and miniaturization. The antenna-in-package (AiP) technology integrates, through package material and process, the antenna into a package carrying a chip, which fully balances the antenna performance, cost and volume and is widely favored by broad chip manufacturers and package manufacturers. Companies including Qualcomm, Intel, IBM and the like have adopted the antenna-in-package technology. Undoubtedly, the AiP technology will also provide a good antenna solution for systems using a 5G millimeter wave mobile communication.

In a band of a millimeter wave frequency, a loss of a metal antenna conductor is severe, which greatly reduces a radiation efficiency of the antenna. Without conductor loss and surface wave loss, the dielectric resonator antenna has a relatively high radiation efficiency which can generally reach above 90%.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a stereoscopic schematic diagram of a mobile terminal;

FIG. 2 is a schematic diagram illustrating a connection between a dielectric resonator antenna-in-package system shown in FIG. 1 and a mainboard;

FIG. 3 is a schematic diagram illustrating a dielectric resonator antenna being fed through a feeding probe;

FIG. 4 illustrates a reflection coefficient of a dielectric resonator antenna-in-package system;

FIG. 5 illustrates an overall efficiency of a dielectric resonator antenna-in-package system;

FIG. 6 illustrates a radiation direction of a dielectric resonator antenna-in-package system when it does not scan at 26.5 GHz;

FIG. 7 illustrates a radiation direction of a dielectric resonator antenna-in-package system when it does not scan at 29.5 GHz;

FIG. 8 illustrates a radiation direction of a dielectric resonator antenna-in-package system when it scans to 55° at 26.5 GHz;

FIG. 9 illustrates a radiation direction of a dielectric resonator antenna-in-package system when it scans to 55° at 29.5 GHz; and

FIG. 10 illustrates a gain CDF curve of a dielectric resonator antenna-in-package system.

### DESCRIPTION OF EMBODIMENTS

The present disclosure will be further illustrated with reference to the accompanying drawings and the embodiments.

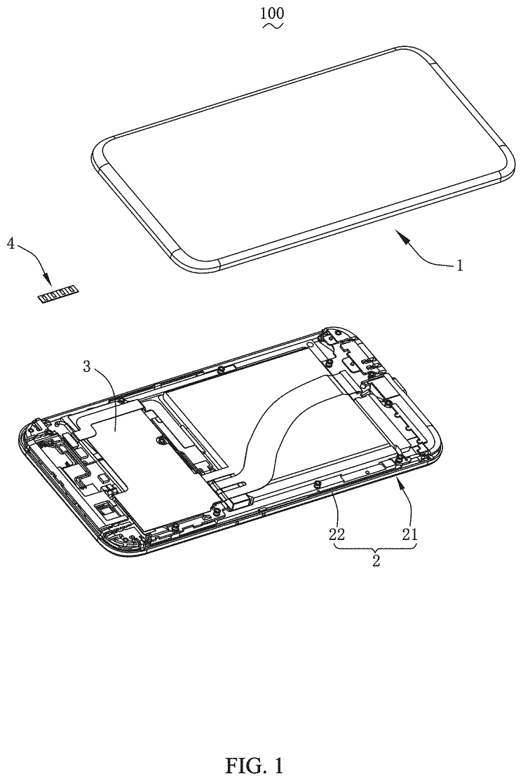

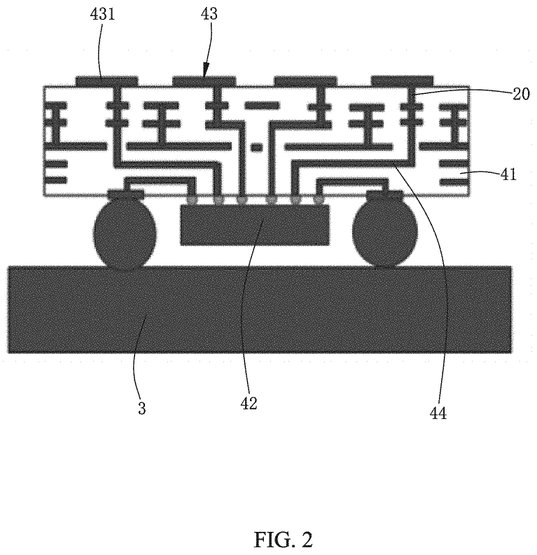

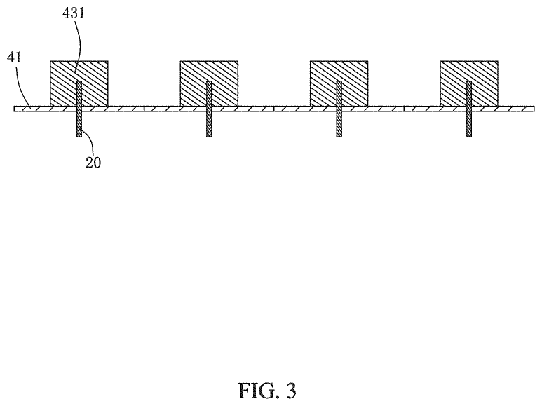

Referring to FIGS. 1-3, the present disclosure provides a mobile terminal 100. The mobile terminal 100 can be a mobile phone, an ipad, a POS machine, etc., which is not limited by the present disclosure. The mobile terminal 100 includes a screen 1, a rear cover 2 covering and connected to the screen 1 and matching with the screen 1 to form a receiving space, a mainboard 3 sandwiched between the screen 1 and the rear cover 2, and a dielectric resonator antenna-in-package system 4 connected to the mainboard 3. The mainboard 3 and the dielectric resonator antenna-in-package system 4 are both received in the receiving space.

The rear cover 2 is a 3D glass rear cover and it can provide better protection, aesthetics, heat diffusion, chroma and user experience. Optionally, the rear cover 2 includes a bottom wall 21 provided opposite to and spaced apart from the screen 1, and a sidewall 22 bent and extending from an outer periphery of the bottom wall 21 towards the screen 1. The sidewall 22 is connected to the screen 1, and the bottom wall 21 and the sidewall 22 are formed into one piece.

The dielectric resonator antenna-in-package system 4 is provided adjacent to the sidewall 22 and parallel with the bottom wall 21. The dielectric resonator antenna-in-package system 4 is configured to receive and transmit electromagnetic wave signals, thereby implementing a communication function of the mobile terminal 100. The dielectric resonator antenna-in-package system 4 can be connected to the mainboard 3 through Ball Grid Array (BGA) technology. That is, the antenna is integrated into a package carrying a chip through a packaging material and a packaging process, and the antenna performance, cost and volume are well taken into consideration, which is favored by majority of chip manufacturers and package manufacturers.

Optionally, the dielectric resonator antenna-in-package system 4 includes a substrate 41 provided between the screen 1 and the rear cover 2, an integrated circuit chip 42 provided on a side of the substrate 41 close to the mainboard 3, a dielectric resonator antenna 43 provided on a side of the substrate 41 facing away from the mainboard 3, and a circuit 44 provided in the substrate 41 and connecting the integrated circuit chip 42 with the dielectric resonator antenna 43.

The dielectric resonator antenna 43 is in a one-dimensional linear array and it includes multiple dielectric resonator antenna units 431. The multiple the dielectric resonator antenna units 431 are sequentially arranged and spaced apart from each other. In the present embodiment, the number of the dielectric resonator antenna units 431 is four. The four dielectric resonator antenna units 431 are sequentially arranged and spaced apart from each other in the same direction.

Optionally, the dielectric resonator antenna-in-package system 4 is a millimeter wave phased array system, and a space occupied by the dielectric resonator antenna-in-package system 4 in a mobile phone is narrowed and can scan in only one angle range, which reduces design difficulty, test difficulty, and beam management.

Optionally, the dielectric resonator antenna 43 is connected to the circuit 44 via a feeding probe 20.

Optionally the dielectric resonator antenna 43 can have any one of a circular shape, a square shape, a hexagon shape or a cross shape. The dielectric resonator antenna 43 is of a symmetrical structure, which is easy to meet a dual polarization requirement. However, the present disclosure does not specifically limit a shape of the dielectric resonator antenna 43, and any shape can be designed according to actual needs, which is within the scope of the present disclosure.

In optional embodiments, the dielectric resonator antenna 43 and the circuit 44 can also be electrically connected through any one of microstrip feed, a slot coupling, or a coplanar waveguide.

Since the dielectric resonator antenna 43 is adopted, a selection range is large and a size and a bandwidth of the dielectric resonator antenna 43 can be flexibly controlled. Without a conductor loss and a surface wave loss, a loss of the dielectric itself is small and thus a dielectric constant of the dielectric resonator antenna 43 has a relatively high radiation efficiency that can generally reach above 90%.

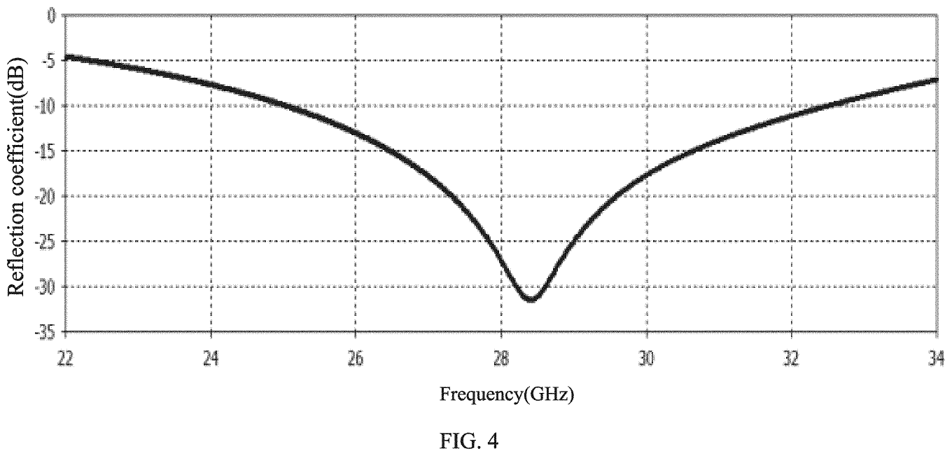

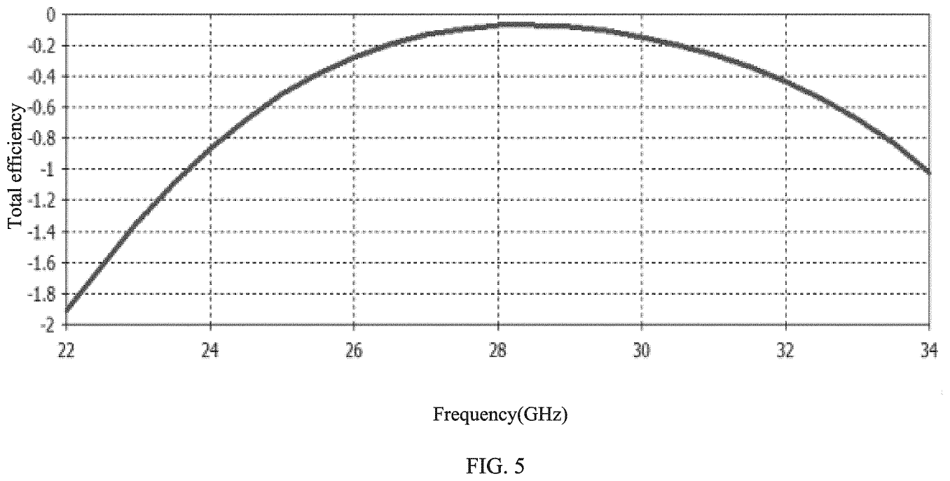

Optionally, as shown in FIG. 4 and FIG. 5, it can be seen that the dielectric resonator antenna-in-package system 4 has a bandwidth of up to 7.5 G and a relative bandwidth of up to 26%, which is much more than meeting the requirements of 5G communication, and it can also be seen that an overall efficiency in an impedance bandwidth is higher than −0.6 dB.

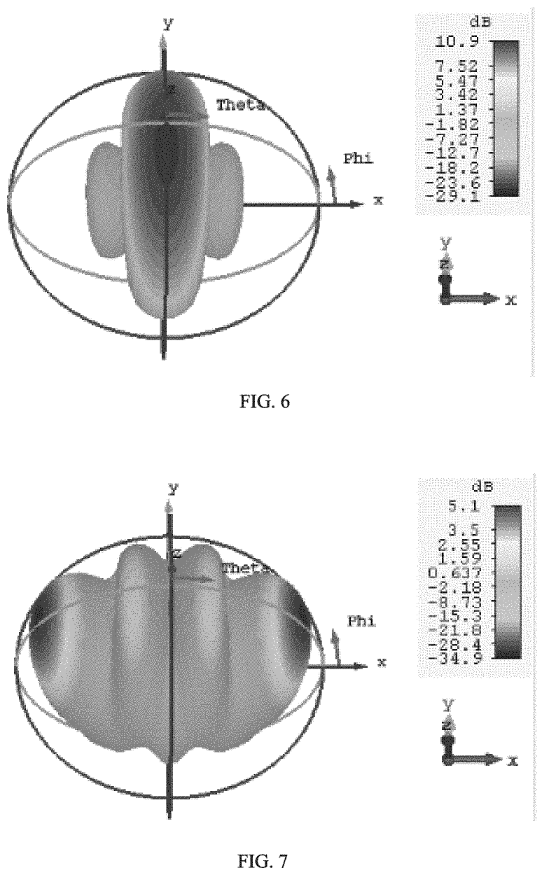

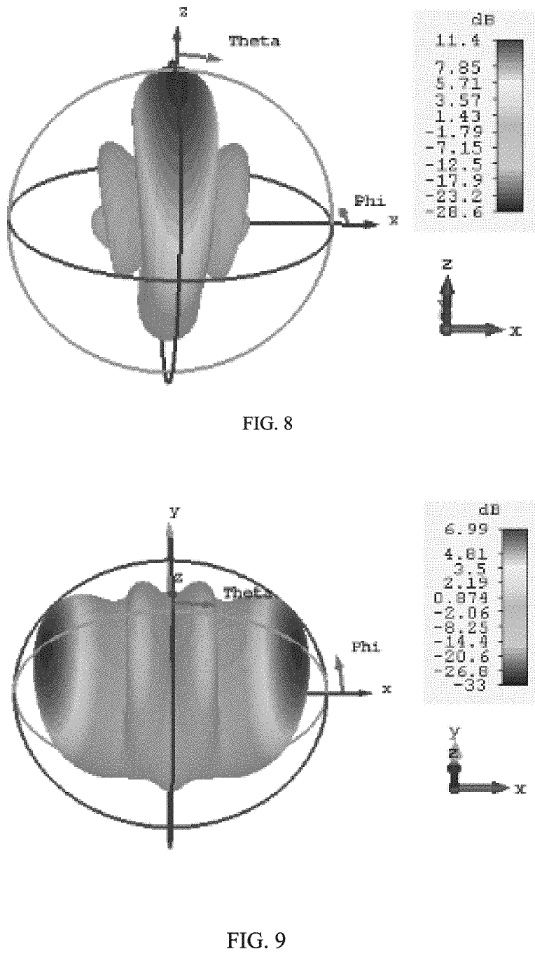

Referring to FIGS. 6-9, the dielectric resonator antenna-in-package system 4 works well at both 26.5 GHz and 29.5 GHz, and effective working in a band of N257 can be effectively achieved.

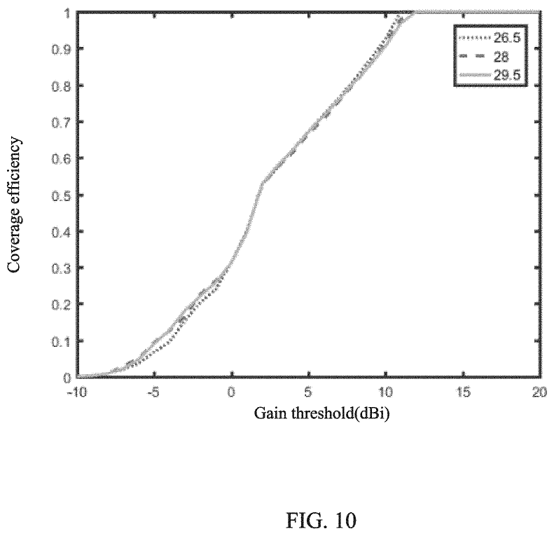

Referring to FIG. 10, a spatial coverage of a terminal including the dielectric resonator antenna-in-package system 4 provided by the present disclosure, is described using a cumulative distribution function (CDF). Here, a gain CDF is an integral of a probability density and defined as CDF(x)=P(Gain≤x), where Gain is the gain. It can be observed that for a case with a 50% coverage, compared to a peak gain, the dielectric resonator antenna-in-package system 4 drops by about 9.6 dB, which is superior to an average of −12.98 dB in a case of 3GPP.

Compared with the related art, the dielectric resonator antenna-in-package system and the mobile terminal provided by the present disclosure has following advantages:

1. The dielectric resonator antenna is adopted, which causes the conductor loss and the surface wave loss to be effectively suppressed and thus has a relatively high radiation efficiency that can generally reach above 90%; and an effect of broadband can be obtained by rationally selecting the dielectric constant;

2. The dielectric resonator antenna is the one-dimensional linear array, and the space occupied by the mobile terminal is narrowed, which reduces design difficulty, test difficulty, and complexity of beam management;

3. The dielectric resonator antenna is symmetrical in structure, and it is easy to meet the dual polarization requirement;

4. For the case of 50% coverage, it is dropped by 9.6 dB lower compared with the peak gain, which satisfies the requirement that the drop does not exceed 12.98 dB in the 3GPP discussion.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. A dielectric resonator antenna-in-package system, applied to a mobile terminal, the mobile terminal comprising a mainboard, wherein the dielectric resonator antenna-in-package system comprises:
a substrate;
a dielectric resonator antenna arranged on a side of the substrate facing away from the mainboard;
an integrated circuit chip arranged on a side of the substrate close to the mainboard; and
a circuit arranged in the substrate and connecting the dielectric resonator antenna with the integrated circuit chip, wherein the circuit is connected to the mainboard.

2. The dielectric resonator antenna-in-package system as described in claim 1, wherein the dielectric resonator antenna is in a one-dimensional linear array and comprises a plurality of dielectric resonator antenna units, and the plurality of the dielectric resonator antenna units is sequentially arranged and spaced apart from each other.

3. The dielectric resonator antenna-in-package system as described in claim 2, wherein the dielectric resonator antenna-in-package system is a millimeter wave phased array antenna system.

4. The dielectric resonator antenna-in-package system as described in claim 3, wherein the dielectric resonator antenna is connected to the circuit through a feeding probe.

5. The dielectric resonator antenna-in-package system as described in claim 1, wherein the dielectric resonator antenna has any one of a circular shape, a square shape, a hexagon shape, or a cross shape.

6. The dielectric resonator antenna-in-package system as described in claim 1, wherein the dielectric resonator antenna and the circuit are electrically connected to each other through any one of microstrip feeding, slot coupling, or coplanar waveguide feeding.

7. A mobile terminal, comprising the dielectric resonator antenna-in-package system as described in claim 1.

8. A mobile terminal, comprising the dielectric resonator antenna-in-package system as described in claim 2.

9. A mobile terminal, comprising the dielectric resonator antenna-in-package system as described in claim 3.

10. A mobile terminal, comprising the dielectric resonator antenna-in-package system as described in claim 4.

11. A mobile terminal, comprising the dielectric resonator antenna-in-package system as described in claim 5.

12. A mobile terminal, comprising the dielectric resonator antenna-in-package system as described in claim 6.
